(19) United States
(12) Patent Application Publication
(10) Pub. No.: US 2012/0254454 A1
(43) Pub. Date: Oct. 4, 2012

(54) IMAGE-BASED SYNCHRONIZATION SYSTEM AND METHOD

(75) Inventors: Matthias Margush, San Francisco, CA (US); Jayesh Sahasi, Fremont, CA (US)

(73) Assignee: ON24, Inc., San Francisco, CA (US)

(21) Appl. No.: 13/074,251

(22) Filed: Mar. 29, 2011

(51) Int. Cl. G06F 15/16

(52) U.S. Cl. 709/231

(57) ABSTRACT

A real-time image-manipulation based synchronization system and method for live or pre-recorded media content, such as an MP4, WebM, Flash, Real, or Windows Media stream, are provided in which the media content is synchronized with a series of interactive elements that are part of a rich media presentation. The media content may be any combination of audio and video data, including webcam output and screen capture output, and the synchronization commands are embedded by modifying the video image (frame) or audio data itself, without the need for a separate (often proprietary) metadata channel, allowing a broad distribution in any video format, including H.264/HTML5.

### FIELD

The disclosure relates to digital streaming media, such as audio, video, animation, etc and application demonstrations, online meetings, and other computer-based collaboration.

### BACKGROUND

There is an overwhelming amount of digital media. A current problem is how to synchronize multiple digital media streams. For example, it is often necessary to have a primary audio or video stream in a presentation and several secondary audio, video, documents, and/or animations that demonstrate something visually or aurally. The secondary stream constitutes only a small portion of the total presentation, so a system must be able to synchronize it with the primary media stream when needed. Additionally, the primary and secondary media streams may be in different formats, requiring different plug-in or helper applications. It is also desirable to avoid a situation in which a user has to download and install a non-ubiquitous or proprietary application or plug-in to synchronize multiple digital media streams.

Existing solutions for this problem have varying success with different components of a Rich Media Presentation, but generally rely on a proprietary application that wraps around the various streaming media elements to ensure their synchronization. Examples of these existing solutions include: WebEx, Placeware/LiveMeeting (Microsoft) and Connect (Adobe). In these systems, the mechanisms used for controlling the synchronization of the various components are proprietary, and unknown to third parties which makes it difficult to third parties to use these systems.

The existing solutions also have limited formats that limit the audience to a proprietary format (Windows Media Player: Microsoft Livemeeting; Flash: Macromedia Breeze; Webex Archive: Webex), limiting flexibility for the consumer. It is desirable, however, to provide a system that can use many different formats.

Most prior solutions limit the total participants to a relatively small number. This may be due, in part, to their mechanism for synchronizing the various elements of the presentation. In particular, whether there is a persistent connection to the server, or a periodic polling mechanism in place to determine the next item to show in the presentation, the overhead associated is significant and limits scalability. Thus, it is desirable to provide a system for synchronizing multiple digital media streams that can be easily scaled.

Prior solutions require the user/viewer to install proprietary applications on their computer. In many corporate environments, this is not allowed by the IT policy, which then prevents access to the Rich Media. Thus, it is desirable to provide a system for synchronizing multiple digital media streams that does not require a proprietary application to be installed on the user's computer.

### BRIEF DESCRIPTION OF THE DRAWINGS

FIG. 1 is a diagram illustrating a method for asset acquisition for an online presentation method;

FIG. 2 is a diagram illustrating an example of an online presentation system that may use the metadata extraction system;

FIG. 3 illustrates a system architecture of the online presentation system shown in FIG. 2;

FIG. 4 is a functional diagram of the interacting components of the online presentation system in FIG. 3;

FIG. 5 is a diagram illustrating a presentation workflow;

FIG. 6 is a diagram illustrating an example of a online presentation client that may incorporate the metadata extraction system;

FIG. 7 illustrates an embodiment of the system for enabling the synchronization of multiple media streams; and

FIG. 8 illustrates an example of the user interface of an administrative tool for media stream synchronization.

### DETAILED DESCRIPTION OF ONE OR MORE EMBODIMENTS

The disclosure is particularly applicable to a web-based meeting system that has multiple digital media stream synchronization and it is in this context that the disclosure will be described. It will be appreciated, however, that the system and method has greater utility since the disclosed image synchronization system can be used with other systems in which it is desirable to be able to synchronize multiple digital media streams and the system can be implemented differently than the implementation disclosed below and be within the scope of the disclosure.

The disclosure relates to system and method for image-based synchronization of live or pre-recorded media content, such as a Flash, Real, or Windows Media stream, with a series of interactive elements that are part of a rich media presentation, and its delivery over the Internet or from a local storage medium. The media content synchronized by the system may be any combination of audio and video data, including webcam output and screen capture output.

In one embodiment, the system is a web-based presentation system that relies on commonly available technology to synchronize multiple media files in a single interface. In one implementation, the system utilizes HTML, JavaScript, Windows Media, Real Media, Flash, digital images and configuration text files. Furthermore, the system provides a single general mechanism for developing and serving Live and on-demand Rich media presentations in Windows Media Player, Real Player, Flash, and can be easily extended to other streaming formats.

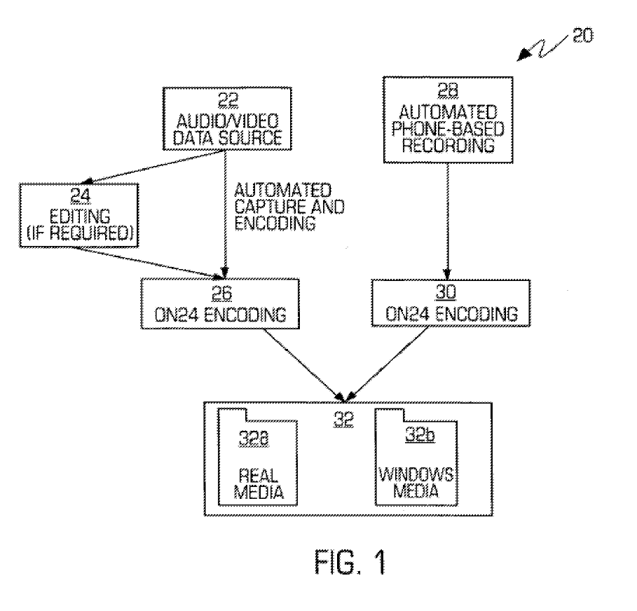

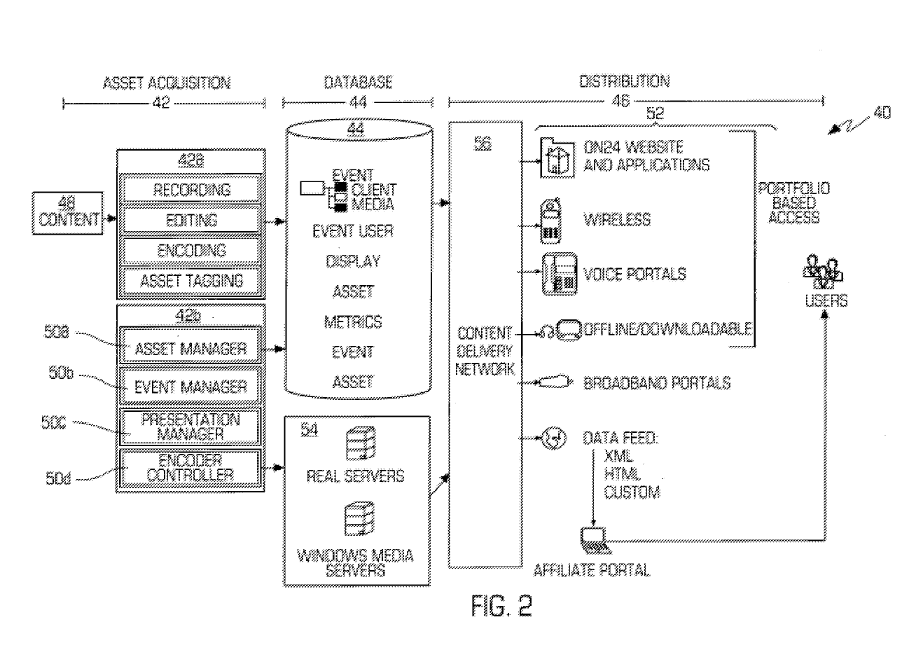

FIG. 1 is a diagram illustrating a method 20 for asset acquisition for online presentation event system. As shown, an audio/video or audio data source 22 is edited in step 24 if necessary or is automatically captured. In step 26, the data source 22 is encoded. Alternatively, an automated phone-based recording source 28 is encoded in step 30. The encoded data may then be stored in a media database 32, such as in a real media format 32a and/or a windows media format 32b. In this manner, a data source/piece of media is prepared for distribution using an event system, an example of which is shown in FIG. 2.

FIG. 2 is a diagram illustrating an event system 40 into which the synchronization apparatus may be incorporated. The event system 40 may comprise an asset acquisition and event management portion 42, a database portion 44 and a distribution portion 46 wherein a piece of media/content 48 is input into the event system 40 in order to distribute that content/piece of media during the event. Generally, each element of the event system being described is implemented in software wherein each portion may be one or more software modules and each software modules may be a plurality of computer instructions being executed to perform a particular function/operation of the system. Each element of the system may thus be implemented as one or more computer resources, such as typical personal computers, servers or workstations that have one or more processors, persistent storage devices and memory with sufficient computing power in order to store and execute the software modules that form the frame event system in accordance with the invention. The event system may generate an event that is provided to one or more event clients 52 wherein each client is a computing resource, such as a personal computer, workstation, cellular phone, personal digital assistant, wireless email device, telephone, etc. with sufficient computing power to execute the event client located on the client wherein the client communicates with the event system over a wired or wireless connection.

In more detail, the asset acquisition and event management portion 42 may further comprise an asset acquisition portion 42a and an event management portion 42b wherein the asset acquisition portion performs one or more of the following functions: recording of the piece of media/content, editing of the piece of media/content, encoding of the piece of media/content and asset tagging. The event manager module 42b further comprises an asset manager module 50a, an event manager module 50b, a presentation manager module 50c and an encoder controller 50d. The asset manager module 50a, prior to an event, imports/exports content/pieces of media into/from a library of media as needed and manages the assets for each event presentation. The event manager module 50b may perform actions/function prior to and after an event. Prior to a particular event, the event manager module may reserve the event in the system (both resources and access points), set-up an event console which a user interacts with to manage the event and then send messages to each recipient of the upcoming event with the details of how to access/operate the event. After a particular event, the event manager module 50b may permit a user to import an old event presentation into the system in order to re-use one or more pieces of the old event presentation. The presentation manager module 50c, during a particular event presentation, generates an event file with the slides of the event presentation, URLs and polls to an encoder controller to distribute the particular event presentation to the users. The encoder controller 50d encodes the event presentation stream to one or more distribution server 54 that distributes the event presentation to the users.

As shown in FIG. 2, the database 44 may include data about each event, including the clients to which the event is being provided and the media associated with the event, one or more event users, the display of the particular event, the assets associated with the event, the metrics for the event and other event data. In combination with this data in the database for a particular event, operations and commands from the event manager module 42b are downloaded to the distribution servers 54 that distribute each event to each client 52 for the particular event over a distribution network 56. As shown, the event/presentation may be distributed to one or more different clients 52 that use one or more different methods to access the event. The clients 52 may include a client that downloads the presentation and then views the presentation offline.

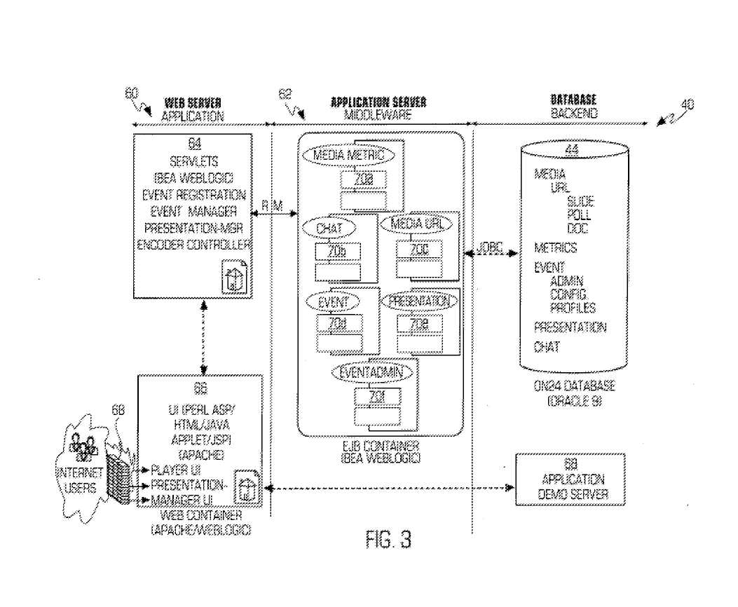

FIG. 3 illustrates more details of the event system shown in FIG. 2. The event system may include a web server portion 60, an application server portion 62 and the database portion 40 (with the database 44) shown in FIG. 2. Each of these portions may be implemented as one or more computer resources with sufficient computing resources to implement the functions described below. In a preferred embodiment, each portion may be implemented as one or more well-known server computers. The web server portion 60 may further comprise one or more servlets 64 and a web container portion 66 which are both behind a typical firewall 68. In a preferred embodiment of the invention, the servlets reside on a BEA Weblogic system which is commercially available and may include an event registration servlet, an event manager module servlet, a presentation manager module servlet and an encoder controller servlet that correspond to the event manager module 50b, presentation manager module 50c and encoder controller 50c shown in FIG. 2. Each of these servlets implement the functions and operations described above for the respective portions of the system wherein each servlet is a plurality of lines of computer code executed on a computing resource with sufficient computing power and memory to execute the operations. The servlets may communicate with the application server portion 62 using well-known protocols such as, in a preferred embodiment, the well-known remote method invocation (RMI) protocol. The servlets may also communicate with the web container portion 66 which is preferable implemented using an well-known Apache/Weblogic system. The web container portion 66 generates a user interface, preferably using Perl Active Server Page (ASP), HTML, XML/XSL, Java Applet, Javascript and Java Server Pages (JSPs.) The web container portion 66 may thus generate a user interface for each client and the presentation manager module user interface. The user interface generated by the web container portion 66 may be output to the clients of the system through the firewall as well as to an application demo server 68 that permits a demo of any presentation to be provided.

The application server portion 62 may preferably be implemented using an Enterprise JavaBeans (EJBs) container implemented using a BEA Weblogic product that is commercially sold. The application server management portion 62 may be known as middleware and may include a media metric manager 70a, a chat manager 70b, a media URL manager 70c, an event manager 70d, a presentation manager 70e and an event administration manager 70f which may each be software applications performed the specified management operations. The application server portion 62 communicates with the database 44 using a protocol, such as the well-known Java Database Connectivity (JDBC) protocol in a preferred embodiment of the invention. The database 44 may preferably be implemented using an Oracle 8/9 database product that is commercially available. As shown, the database 44 may include media data including URL data, slide data, poll data and document data. The database 44 may further include metric data, event data and chat data wherein the event data may further preferably include administration data, configuration data and profile data.

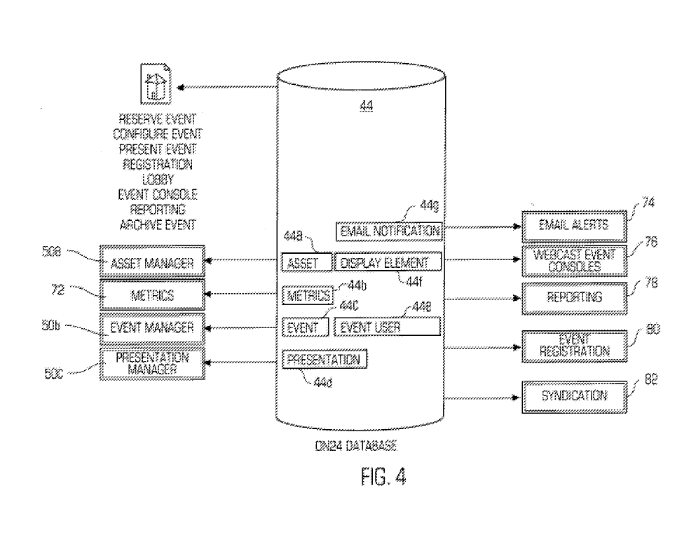

FIG. 4 is a diagram illustrating more details of the event database 44 in FIG. 3. As shown in FIG. 4, the database may generate data that is used to implement a function to reserve an event, to configure an event, a present an event, for registration, for the lobby. for the event console, for reporting and for archiving an event. The database may include asset data 44a that may be provided to the asset manager module 50a, metrics data 44b that is provided to a metric module 72, event data 44c that is provided to the event manager module 50b, presentation data 44d that is provided to the presentation manager module 50c, event user data 44e that is provided to an event registration module 80, display element data 44f that is provided to an event consoles module 76 and email notification data 44g that is provided to an email alerts module 74. The database may also store data that is used by a reporting module 78 to generate reports about the events and presentations provided by the system. The database may also store data that is used by a syndication module 82 to syndicate and replicate existing presentations.

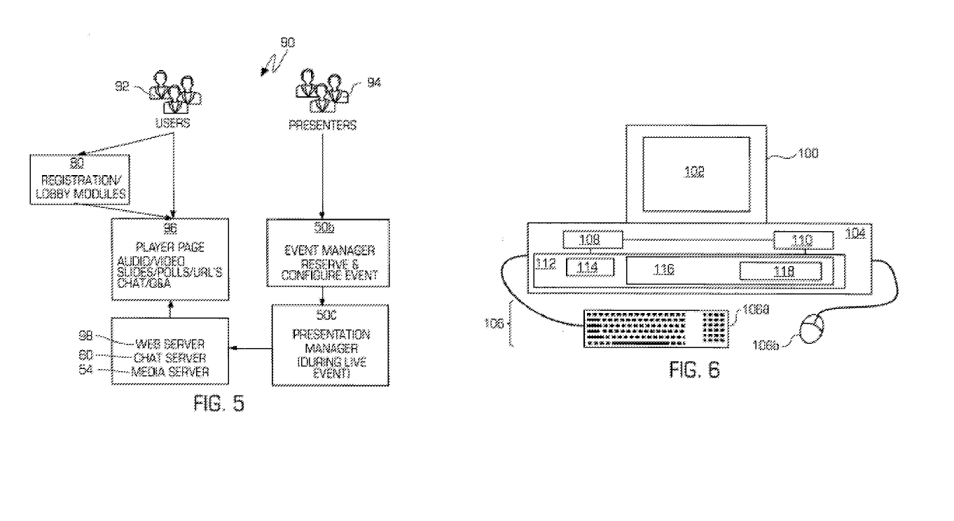

FIG. 5 is a diagram illustrating an event center 90 that may be utilized by one or more users 92 that are presented with a presentation by the system and one or more presenters 94 who utilize the system to present presentations to the users 92. The users 92 may interact with a registration and lobby modules 80 that permit the users to register with the system and schedule a presentation to view. In response to a successful registration, the user may be presented with a player page 96, such as a web page provided to a client computer of the user, that provides the audio and visual data for the presentation, slides, polls and URLs for the presentation, chat sessions and question and answers for a particular presentation. The data in the player page 96 is provided by the web server 60, the media server 54 and a chat server 98 that provides the chat functionality for a presentation. The presentation data for a live event presentation is provided to the servers 54, 60 and 98 by the presentation manager module 50c. The presenters 94 may utilize the event manager module 50b to reserve an event and/or configure an event. Once the event is reserve and configured, the presentation data is forwarded to the presentation manager module 50c.

FIG. 6 is a diagram illustrating an example of a online presentation client 100 that may incorporate the metadata extraction apparatus. The event client 100 may be implemented as a personal computer, workstation, PDA, cellular phone and the like with sufficient computing power to implement the functions of the client as described below. In the example shown in FIG. 6, the event client may be a typical personal computer that may further comprise a display unit 102, such as a CRT or liquid crystal display or the like, a chassis 104 and one or more input/output devices 106 that permit a user to interact with the client 100, such as, for example, a keyboard 106a and a mouse 106b. The chassis 104 may further include one or more processors 108, a persistent storage device 110, such as a hard disk drive, optical disk drive. tape drive, etc., and a memory 112, such as SRAM, DRAM or flash memory. In a preferred embodiment, the client is implemented as one or more pieces of software stored in the persistent storage device 110 and then loaded into the memory 112 to be executed by the processor(s) 108. The memory may further include an operating system 114, such as Windows, and a typical browser application 116, such as Microsoft Internet Explorer, Mozilla Firefox or Netscape Navigator and an event console module 118 (including a slide, polls, survey, URL, Q&A) that operates within the browser application. The client side of the system/apparatus is implemented as HTML and Javascript code that is downloaded/streamed to the client 100 during/prior to each presentation so that the synchronization of the assets does not require separate client software downloaded to the client.

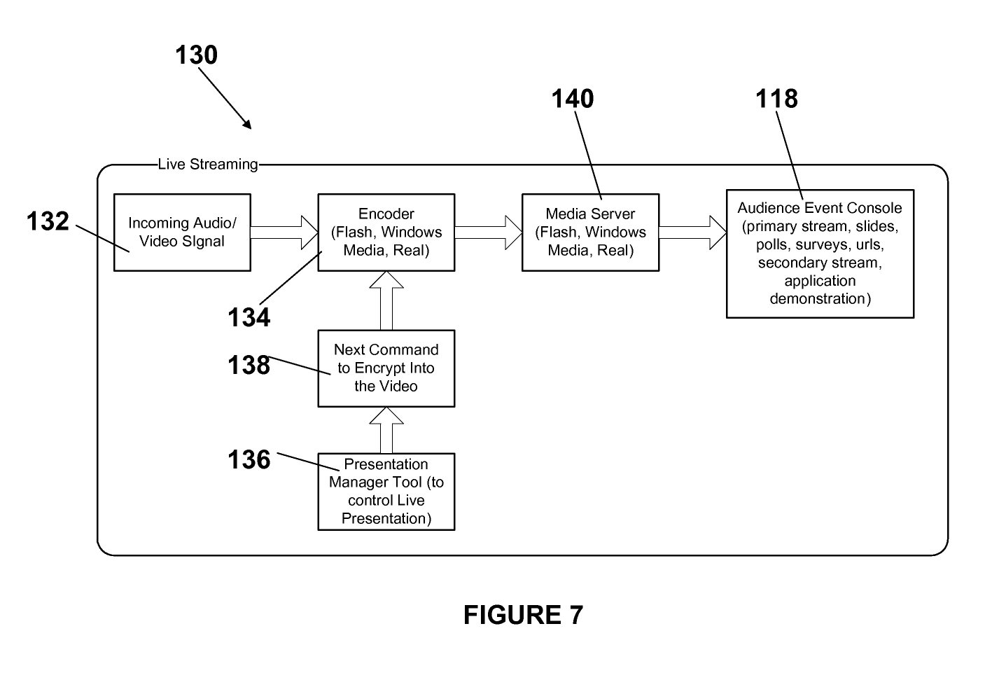

The multiple digital stream synchronization in the context of the above described presentation system is now described. The streaming presentations include an audio or video stream, in which a stream is delivered to the end-user from some type of streaming media server (e.g. Flash Media Server, Windows Media Server, Real Media Server, Wowza server, etc.). The source of the audio or video may be a phone call, pre-recorded audio in any format, or an incoming video signal. The synchronization for live streaming events is handled by embedding metadata into the stream as it is being encoded which can be done using a system 130 for enabling the synchronization of multiple media streams that is part of the multiple digital media stream synchronization as shown in FIG. 7. The system described can also be used for on-demand (archived) streams since the synchronization data is already embedded in the stream by the system. The system may receive an input stream/signal 132 that is fed into an encoder 134 (a Flash. Windows Media or Real Networks streaming encoder, for example) along with metadata from a presentation manager tool 136 (that controls the live presentation) wherein the metadata includes a next synchronization command 138 that is then encoded/encrypted (such as by stenography) into the stream by the encoder 134. The encoded stream is then fed to a media server 140 (a Flash. Windows Media or Real Networks media server, for example) that serves the multiple streams to the audience event console 118 that may present the primary streams, slides, polls. Surveys, URLs, secondary streams and application demonstrations, for example).

While prior solutions seem to have attempted to embed metadata into the stream itself, the mechanism has been to leverage a metadata channel enabled by the proprietary stream formats (Flash, Windows Media, Real, etc.). In the synchronization system of the disclosure, by modifying the outgoing stream itself—and storing the metadata as encrypted within the stream data itself, the disclosed synchronization system remove the reliance on any separate metadata channel. In essence, the synchronization command (e.g., which slide or poll to show with a video frame (or audio packet)) is embedded within the video (or audio) itself. As a result, the synchronization system can use the new H.264 emerging video standard with HTML5 standard—neither of which specify a metadata channel capability. Thus, the synchronization system can use a stream sent into a HTML5-compliant browser without the need for any media player or plugin, and decrypt the synchronization commands hidden in the stream data (such as a video image.) These synchronization commands can be in any format—although in this embodiment we use a URL to convey the command to the Audience watching the Event Console (display this URL now, show this particular slide now, bring up a pre-configured poll in front of the audience member, start playing a short video demo clip, stop playing clip, show mouse pointer or whiteboard, etc.) are then interpreted by application code in the browser to effect action on the browser. The browser actions may include launching a survey, flipping to the next slide in a presentation, refreshing or closing the browser, blocking a particular user, and launching a different URL, among others.

On-Demand Media Stream Synchronization

For On-demand presentations, the typical prior approach has been to have timings associated with the various elements are known is advance, and the bulk of the logic is in a local scripting language (e.g., Javascript). It continually access and controls the media players (Windows Media Player, Real Player, Flash Player) in the browser to determine what components of the presentation should be visible at any given time, and displays the appropriate content. In contrast, as described above, the synchronization commands are hidden in the media itself and can be extracted from there to drive the rest of the elements within the presentation.

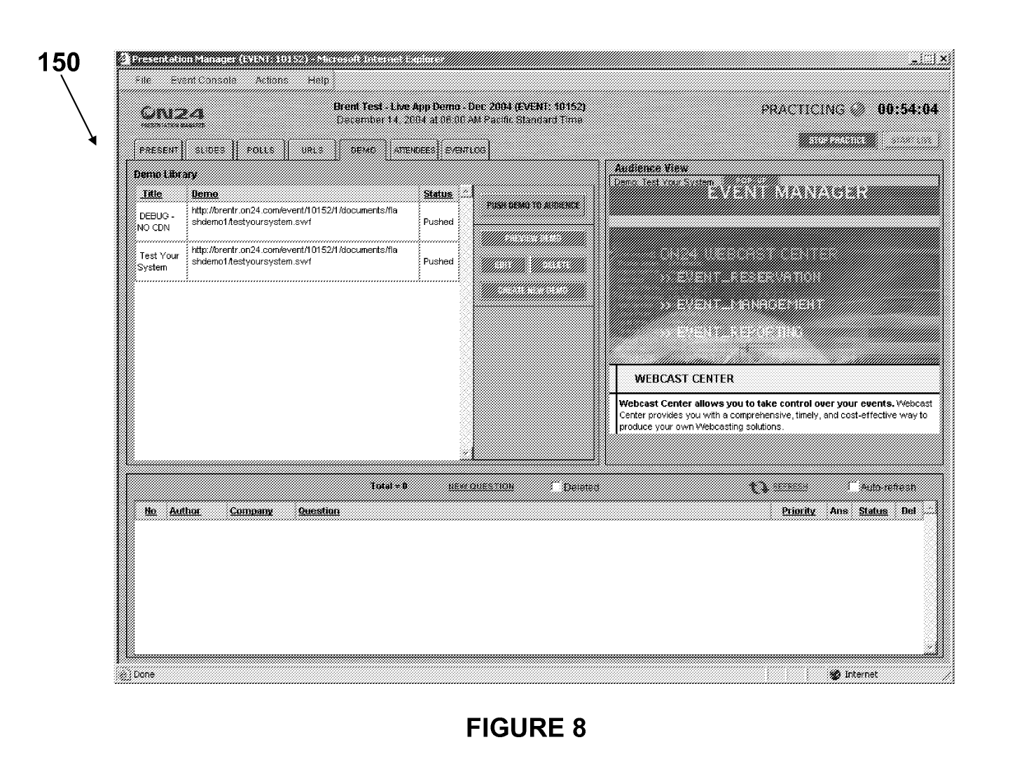

FIG. 8 illustrates an example of the user interface 150 of an administrative tool (called “Presentation Manager (136 in FIG. 7)” for media stream synchronization. In this illustration various tabs are displayed across the top—“Present”, “Slides”, “Polls”, “URL's”, “Demo”. Each of those tabs allow a Presenter to control what the audience will ultimately see on their consoles during a Live event (and this synchronization will be retained for the Archived version). The “Slides” tab shows a thumbnail of the various slides from an uploaded presentation deck (Powerpoint, for example. The Presenter is able to preview the slides, and decide which one to “push” to the audience. The Polls or URL's tab similarly allow the presenter to add content of that type and then “push” to the audience. The “Demo” tab allows for pushing short video clips to the audience. When something is “pushed” by the presenter, the data is submitted via HTTP to the weblogic server and into a database. The encoder (FIG. 7: 134) polls the database for such changes, and embeds the command for the appropriate “pushed” action into the stream by manipulating the video image (frame) or audio data and hiding this command within it.

The system is to be able to manipulate the outgoing stream on the fly (Live), before it is transmitted to the audience, and then being able to decrypt the information hidden within the video to drive synchronization within a rich media presentation. This allows the system to be used with a standards-based, no-plugin/proprietary video player architecture, with full support for HTML5-compliant browsers and H.264 Rich Media Presentation. In addition, the stream, such as a video, can be edited using commonly available tools, and still retains its embedded metadata and ability to drive and synchronize elements of the Rich Media Presentation, because the metadata is part of the stream itself.

While the foregoing has been with reference to a particular embodiment of the invention, it will be appreciated by those skilled in the art that changes in this embodiment may be made without departing from the principles and spirit of the disclosure, the scope of which is defined by the appended claims.

1. An apparatus for encoding a synchronization code into a plurality of digital media streams so that the plurality of digital media streams can be synchronized, the apparatus comprising:
an encoder that receives a digital media stream;
a presentation manager tool that generates one or more synchronization commands for the digital media stream; and
the encoder embeds the one or more synchronization commands into the digital media stream and then encodes the embedded one or more synchronization commands and the digital media stream into an encoded digital media stream that is streamable to a user, whereby the encoded digital media stream is synchronizable with a plurality of digital media streams without a separate metadata channel.

2. The apparatus of claim 1, wherein each digital media stream is one of a video stream, an audio stream and a digital data stream.

3. The apparatus of claim 1, wherein each synchronization command is one of a launch survey command, a flip to next presentation slide command, a refresh browser command, a close browser command, a block a particular user command and a launch a different URL command.

4. The apparatus of claim 1, wherein the encoder encrypts the one or more synchronization commands directly into the digital media stream by manipulating the digital media stream without the need for a separate metadata channel.

5. A method for encoding a synchronization code into a plurality of digital media streams so that the plurality of digital media streams can be synchronized, the method comprising:
receiving a digital media stream;
generating one or more synchronization commands for the digital media stream;
embedding, using an encoder, the one or more synchronization commands into the digital media stream; and encoding, using the encoder, the embedded one or more synchronization commands and the digital media stream into an encoded digital media stream that is streamable to a user, whereby the encoded digital media stream is synchronizable with a plurality of digital media streams without a separate metadata channel.

6. The method of claim 5, wherein each digital media stream is one of a video stream, an audio stream and a digital data stream.

7. The method of claim 5, wherein each synchronization command is one of a launch survey command, a flip to next presentation slide command, a refresh browser command, a close browser command, a block a particular user command and a launch a different URL command.

8. The method of claim 5, wherein embedding the one or more synchronization commands further comprises encrypting, using the encoder, the one or more synchronization commands into the digital media stream.

9. An apparatus for synchronizing a plurality of digital media streams so that the plurality of digital media streams are synchronized for an audience event console, the apparatus comprising:
an audience event console on a computer that is capable of displaying an event presentation with the plurality of digital media streams;
an event system, coupleable to the computer with the audience event console, that has an encoder that encodes each digital media stream to generate an encoded digital media stream for each digital media stream and a media streamer that streams a plurality of encoded media streams to the audience event console;
wherein each encoded digital media stream further comprises one or more synchronization commands that are embedded into the digital media stream and digital media stream;
wherein the audience event console receives each encoded digital media stream and extracts the one or more synchronization commands from each encoded digital media stream so that the audience event console synchronizes the plurality of digital media streams based on the extracted one or more synchronization commands in each encoded digital media stream.

10. The apparatus of claim 9, wherein each digital media stream is one of a video stream, an audio stream and a digital data stream.

11. The apparatus of claim 9, wherein each synchronization command is one of a launch survey command, a flip to next presentation slide command, a refresh browser command, a close browser command, a block a particular user command and a launch a different URL command.

12. The apparatus of claim 9, wherein the encoder encrypts the one or more synchronization commands into the digital media stream.

13. The apparatus of claim 9, wherein the audience event console further comprises a piece of software being executed by the computer.

14. The apparatus of claim 9, wherein the audience event console further comprises a piece of code being executed within a browser on the computer.

15. A method for synchronizing a plurality of digital media streams so that the plurality of digital media streams are synchronized for an audience event console, the method comprising:
encoding, using an encoder in an event system, each digital media stream to generate an encoded digital media stream for each digital media stream, wherein each encoded digital media stream further comprises one or more synchronization commands that are embedded into the digital media stream and digital media stream;
streaming, using a media streamer of the event system, a plurality of encoded media streams to an audience event console on a remote computer;
receiving, at the audience event console on the remote computer, each encoded digital media stream;
extracting, using the audience event console on the remote computer, the one or more synchronization commands from each encoded digital media stream; and
synchronizing, on the audience event console on the remote computer, the plurality of digital media streams based on the extracted one or more synchronization commands in each encoded digital media stream.

16. The method of claim 15, wherein each digital media stream is one of a video stream, an audio stream and a digital data stream.

17. The method of claim 15, wherein each synchronization command is one of a launch survey command, a flip to next presentation slide command, a refresh browser command, a close browser command, a block a particular user command and a launch a different URL command.

18. The method 15, wherein encoding each digital media stream further comprises encrypting, using the encoder, the one or more synchronization commands into the digital media stream.
